(19) United States
(12) Patent Application Publication
(10) Pub. No.: US 2019/0258214 A1
(43) Pub. Date: Aug. 22, 2019

(54) INFORMATION PROCESSING SYSTEM AND INFORMATION PROCESSING METHOD

(71) Applicant: Mitsubishi Electric Corporation, Tokyo (JP)

(72) Inventor: Tetsuharu IWAYAMA, Tokyo (JP)

(73) Assignee: Mitsubishi Electric Corporation, Tokyo (JP)

(21) Appl. No.: 16/346,877

(22) PCT Filed: Sep. 25, 2017
(86) PCT No.: PCT/JP2017/034507

§ 371 Date: May 2, 2019

(51) Int. Cl. G05B 19/042; H04L 29/08

(52) U.S. Cl. CPC G05B 19/0428; G05B 2219/31121; H04L 67/12

(57) ABSTRACT

An information processing system includes a field devices that output field information to be subjected to information processing, and an edge device that generates primary analysis information by performing primary analysis on the field information and extracts extraction field information from the field information. Further, the system includes a cloud server that generates second analysis information by performing secondary analysis on the primary analysis information and the extraction field information, and a client that generates tertiary analysis information for controlling the field devices or for the field devices to operate, based on the secondary analysis information, in which the edge device controls the field devices or causes the field devices to operate, by using the tertiary analysis information based on statuses of the field devices.

### FIELD

The present invention relates to an information processing system and an information processing method that execute control based on information acquired from a field device.

### BACKGROUND

A field device such as a programmable logic controller (PLC), which is used in a field of factory automation (FA) that automates a production process of a factory, generates a large amount of data such as control data, event data, alarm data, and sensor data.

However, an information processing device arranged in the factory lacks calculation ability to process the large amount of data generated by the field device. In addition, since the information processing device in the factory is arranged in a closed network, it is necessary to leave processing of the data to a so-called cloud server connected to a network outside the factory to share the data between factories geographically separated from each other.

A system of Patent Literature 1 collects and analyzes data at a cloud server and a location called an edge closer to a factory than the cloud server. As a result, the system of Patent Literature 1 executes both of control in which a real-time property is required and control based on a status of a field device to be controlled.

### CITATION LIST

### Patent Literature

Patent Literature 1: U.S. Pat. No. 9,253,054

### SUMMARY

### Technical Problem

However, in Patent Literature 1 described above, which is a conventional technique, since an analysis result in the cloud server is directly reflected in the field device, there has been a problem that validity of the analysis result in the cloud server cannot be determined. For this reason, in Patent Literature 1, which is the conventional technique, there has been a risk on system management.

The present invention has been made in view of the above, and it is an object to obtain an information processing system enabled to execute both the control in which the real-time property is required and the control based on the status of the field device while reducing the risk on the system management.

### Solution to Problem

To solve the problem described above and achieve the object, an information processing system of the present invention includes a field device that outputs first information to be subjected to information processing, and a primary analysis device that generates primary analysis information by performing primary analysis on the first information and extracts second information from the first information. In addition, the information processing system of the present invention includes a secondary analysis device that generates secondary analysis information by performing secondary analysis on the primary analysis information and the second information, and a client device that generates control information for controlling the field device or for the field device to operate, based on the secondary analysis information. In addition, in the information processing system of the present invention, the primary analysis device controls the field device or causes the field device to operate, by using the control information based on a status of the field device.

### Advantageous Effects of Invention

The information processing system according to the present invention has an effect that the system is enabled to execute the control in which the real-time property is required and the control based on the status of the field device while reducing the risk on the system management.

### BRIEF DESCRIPTION OF DRAWINGS

FIG. 1 is a diagram illustrating a configuration of an information processing system according to a first embodiment of the present invention.

FIG. 2 is a diagram illustrating a configuration of an edge device according to the first embodiment.

FIG. 3 is a diagram illustrating a configuration of a cloud server according to the first embodiment.

FIG. 4 is a diagram illustrating a configuration of a client according to the first embodiment.

FIG. 5 is a flowchart illustrating an operation processing procedure of the information processing system according to the first embodiment.

FIG. 6 is a flowchart illustrating an operation processing procedure of the information processing system according to a second embodiment.

FIG. 7 is a flowchart illustrating an operation processing procedure of the information processing system according to a third embodiment.

FIG. 8 is a diagram illustrating a configuration of an information processing system according to a fourth embodiment.

FIG. 9 is a diagram illustrating a hardware configuration example of the client according to the first to fourth embodiments.

### DESCRIPTION OF EMBODIMENTS

Hereinafter, an information processing system and an information processing method according to embodiments of the present invention will be described in detail with reference to the drawings. Note that, the invention is not limited to the embodiments.

### First Embodiment

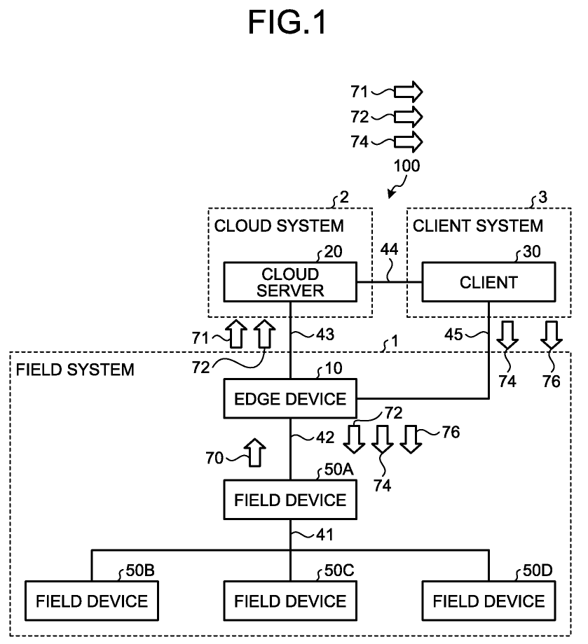

FIG. 1 is a diagram illustrating a configuration of an information processing system according to a first embodiment of the present invention. An information processing system 100 is a system used in a field of FA, and executes data processing of data collected from various devices and control to the devices based on the data processing.

The information processing system 100 includes a field system 1 arranged in a factory including a production line, a cloud system 2 connected to the field system 1, and a client system 3 connected to the field system 1 and the cloud system 2.

The field system 1 includes field devices 50A to 50D that execute various types of operation or control and an edge device 10 that collects data of the field devices 50A to 50D. An example of each of the field devices 50A to 50D is a PLC, a servo amplifier, a servomotor, an inverter, a numerical control device, an input/output device, or a sensor. Hereinafter, a case will be described where the field device 50A is the PLC, and each of the field devices 50B to 50D is the servo amplifier, the servomotor, the inverter, the numerical control device, the input/output device, or the sensor.

The field devices 50A to 50D are connected to each other via a field network 41. In addition, the field device 50A is connected to the edge device 10 via a field network 42. Note that, the field device 50A may be connected to the edge device 10 by using a network of Ethernet (registered trademark) instead of the field network 42. In addition, the field devices 50A to 50D may be connected to each other by using a network of Ethernet instead of the field network 41.

The field devices 50A to 50D generate at least one of control data, event data, alarm data, or sensor data. The control data is data for controlling a device to be controlled such as a sensor or a robot, and the event data is data indicating states of operation of the field devices 50A to 50D. In addition, the alarm data is data of alarms generated when the field devices 50A to 50D give notifications of abnormalities, and the sensor data is data detected by the sensor. An example of sensor data is data of temperature, humidity, or vibration.

The data generated by the field devices 50A to 50D include data for which a real-time property is required and data for which the real-time property is not required. The field devices 50B to 50D send the collected data or the generated data to the field device 50A. In addition, the field device 50A sends the collected data or the generated data to the edge device 10. The data collected or generated by the field devices 50B to 50D are therefore sent by the field device 50A to the edge device 10. In the following description, the data collected by the field device 50A or the data generated by the field device 50A is referred to as field information 70. The field information 70 that is first information is data to be subjected to information processing in the information processing system 100, and is sent from the field device 50A to the edge device 10.

The edge device 10 is a device arranged on a higher order side in the network topology than the field devices 50A to 50D. In the following description, the cloud system 2 and the client system 3 in the information processing system 100 are referred to the higher order side or a cloud side, and the field devices 50B to 50D are referred to a lower order side or a field side. The edge device 10 is connected to a client 30 arranged in the client system 3 via a communication line 45. In addition, the edge device 10 is connected to a cloud server 20 arranged in the cloud system 2. Note that, the edge device 10 may be directly connected to the cloud server 20 or may be indirectly connected to the cloud server 20 via an access network 43. The access network 43 may be a wired network such as Ethernet, or a wireless network such as a wireless local area network (LAN) or a mobile communication network. In addition, the edge device 10 may be connected to the cloud server 20 via a plurality of communication devices such as switches or routers. Hereinafter, a case will be described where the edge device 10 is connected to the cloud server 20 via the access network 43.

The edge device 10 that is a primary analysis device is a computer that collects and performs primary analysis on the field information 70 that is the data of the field devices 50A to 50D. The edge device 10 extracts data necessary for the cloud server 20 from the field information 70. The edge device 10 extracts, as the data necessary for the cloud server 20, for example, device data or output values of the field devices 50A to 50D in a specific period that is a period before and after a point of time at which the field devices become abnormal in a case where it is determined that the field devices 50A to 50D are in abnormal states. In addition, the edge device 10 controls the field devices 50A to 50D, based on an analysis result of the primary analysis. In addition, the edge device 10 controls the field devices 50A to 50D in accordance with a control instruction sent from the client 30. In the following description, information on the analysis result of the primary analysis by the edge device 10 is referred to as primary analysis information 72. In addition, information to the cloud server 20, which is extracted by the edge device 10 from the field information 70, is referred to as extraction field information 71. The edge device 10 sends the primary analysis information 72, and the extraction field information 71 that is second information, to the cloud server 20. In addition, the edge device 10 controls the field devices 50A to 50D by using the primary analysis information 72, secondary analysis information 74 to be described later, and tertiary analysis information 76 to be described later.

The cloud server 20 is a device on the higher order side than the edge device 10, and one or more cloud servers 20 are arranged in the cloud system 2. The cloud server 20 is connected to the client 30 via a communication line 44. The cloud server 20 is a computer that stores data sent from the edge device 10, and may be constructed with a virtual server.

The cloud server 20 that is a secondary analysis device performs secondary analysis on the primary analysis information 72 and the extraction field information 71 sent from the edge device 10. In the following description, information on an analysis result of the secondary analysis by the cloud server 20 is referred to as the secondary analysis information 74. The cloud server 20 sends the secondary analysis information 74, the primary analysis information 72, and the extraction field information 71 to the client 30.

The client 30 that is a client device is a device on the higher order side than the edge device 10, and one or more clients 30 are arranged in the client system 3. In a case where a plurality of the clients 30 is arranged, the clients 30 may be arranged at locations geographically separated from each other. The client 30 is a computer that performs tertiary analysis on data sent from the cloud server 20. In the following description, information on an analysis result of the tertiary analysis by the client 30 is referred to as the tertiary analysis information 76. The client 30 sends the tertiary analysis information 76 and the secondary analysis information 74 to the edge device 10. The secondary analysis information 74 is information to be used for remote monitoring and analysis of the field system 1, and the tertiary analysis information 76 is information to be used for maintenance and operation of the field system 1. The secondary analysis information 74 is information to be generated by automatic analysis or determination by a computer such as the cloud server 20. On the other hand, the tertiary analysis information 76 is information generated by the client 30, based on a determination result finally determined by a human who is a user of the client 30.

Based on the primary analysis information 72, the secondary analysis information 74, the tertiary analysis information 76, the field information 70, and the extraction field information 71, the information processing system 100 executes processing such as creation of a production plan, analysis of an operating status, diagnosis of a lifetime, management of quality, or control of the field devices 50A to 50D. Note that, in the following description, the primary analysis information 72, the secondary analysis information 74, or the tertiary analysis information 76 may be referred to as analysis information.

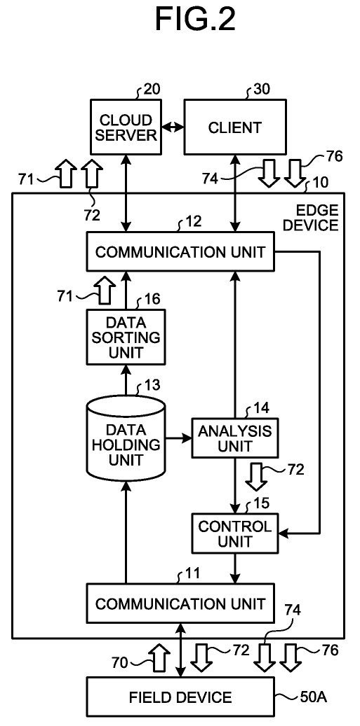

FIG. 2 is a diagram illustrating a configuration of the edge device according to the first embodiment. The edge device 10 includes a communication unit 11 that performs transmission and reception of data with the field device 50A, and a communication unit 12 that performs transmission and reception of data with the cloud server 20 and the client 30. In addition, the edge device 10 includes a data holding unit 13 that holds the field information 70 that is data received by the communication unit 11 from the field device 50A, and an analysis unit 14 that performs primary analysis on the field information 70 held by the data holding unit 13. In addition, the edge device 10 includes a control unit 15 that controls the field device 50A, based on the primary analysis information 72 indicating an analysis result by the analysis unit 14. In addition, the edge device 10 includes a data sorting unit 16 that extracts the extraction field information 71 that is information of which the cloud server 20 can be notified, in the field information 70 held in the data holding unit 13, and sends the extraction field information 71 to the communication unit 12.

The communication unit 11 receives the field information 70 from the field device 50A and sends the field information 70 to the data holding unit 13. In addition, the communication unit 11 sends the primary analysis information 72 generated by the analysis unit 14 to the field device 50A. In addition, the communication unit 11 sends, to the field device 50A, the secondary analysis information 74 and the tertiary analysis information 76 sent from the client 30. The primary analysis information 72, the secondary analysis information 74, and the tertiary analysis information 76 sent by the communication unit 11 to the field device 50A are control information for controlling any one of the field devices 50A to 50D. The data holding unit 13 includes a storage unit such as a memory, and holds the field information 70 sent from the communication unit 11.

The analysis unit 14 reads the field information 70 from the data holding unit 13, and performs primary analysis on the field information 70. A processing example of the primary analysis is processing of analyzing whether the field devices 50A to 50D are in the abnormal states, based on the field information 70, by the analysis unit 14. In this case, if it is determined that the field devices 50A to 50D are in the abnormal states, the analysis unit 14 generates stop instruction information for stopping the field devices 50A to 50D, or skip instruction information for skipping a work process. The stop instruction information or the skip instruction information generated by the analysis unit 14 is an example of the primary analysis information 72. The stop instruction information is a stop instruction for the work process being executed by the field devices 50A to 50D, and the skip instruction information is a skip instruction for the work process being executed by the field devices 50A to 50D. Upon generating the primary analysis information 72, the analysis unit 14 sends the primary analysis information 72 generated, to the control unit 15 and the communication unit 12.

The control unit 15 converts the primary analysis information 72, the secondary analysis information 74 from the client 30, and the tertiary analysis information 76 from the client 30 into formats interpretable by the field device 50A. The control unit 15 sends the primary analysis information 72, the secondary analysis information 74, and the tertiary analysis information 76 after the format conversion, to the communication unit 11. Then, the communication unit 11 sends the primary analysis information 72, the secondary analysis information 74, and the tertiary analysis information 76 from the control unit 15, to the field device 50A. Further, in a case where the analysis information from the edge device 10 is analysis information to the field devices 50B to 50D, the field device 50A sends the analysis information from the edge device 10 to the field devices 50B to 50D. As a result, feedback control is executed to the field devices 50A to 50D by the edge device 10 or the client 30. As described above, the analysis information is feedback data to be used for the feedback control to the field devices 50A to 50D.

In the analysis information, the primary analysis information 72 is data to be used for real-time control to the field devices 50A to 50D. The edge device 10 therefore controls the field devices 50A to 50D in real time by using the primary analysis information 72 generated based on the field information 70.

In addition, the secondary analysis information 74 is data generated based on an operation history of the field system 1, and the tertiary analysis information 76 is data generated based on a status of the field system 1. The edge device 10 therefore executes non-real-time control on the field devices 50A to 50D by using the secondary analysis information 74 and the tertiary analysis information 76.

The data sorting unit 16 reads the field information 70 from the data holding unit 13, and sorts the field information 70 into data to be transmitted to the cloud server 20 and data not to be transmitted to the cloud server 20. Specifically, the data sorting unit 16 sorts the field information 70 into the primary analysis information 72 necessary for the real-time control and the extraction field information 71 to be used for predictive maintenance of failure of the field devices 50A to 50D. In the field system 1, the field devices 50A to 50D generate enormous amounts of the field information 70 such as control data, event data, alarm data, and sensor data. The field information 70 is collected by each field system 1, and sent to the client 30 or the cloud server 20. In this case, in each field system 1, the data sorting unit 16 extracts the extraction field information 71 to be used for the predictive maintenance of failure from the field information 70. The data sorting unit 16 sends the extraction field information 71 to the communication unit 12.

The communication unit 12 sends the extraction field information 71 and the primary analysis information 72 to the cloud server 20. In addition, the communication unit 12 receives the secondary analysis information 74 and the tertiary analysis information 76 sent from the client 30, and sends the analysis information to the control unit 15. Note that, in a case where the secondary analysis information 74 is sent from the cloud server 20, the communication unit 12 may receive the secondary analysis information 74 and send the analysis information to the control unit 15.

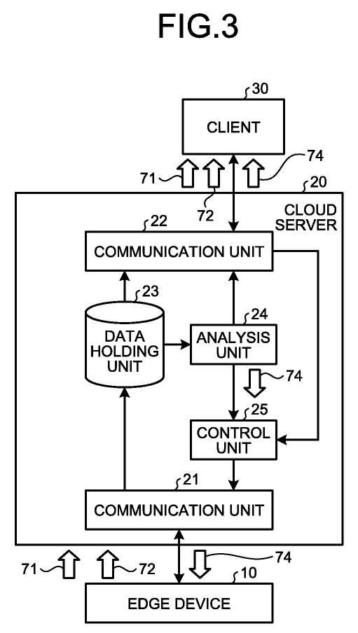

FIG. 3 is a diagram illustrating a configuration of the cloud server according to the first embodiment. An example of the cloud server 20 is a virtual server enabled to change scale or performance of a storage and a central processing unit (CPU) depending on an amount of data to be processed or a processing speed. The cloud server 20 is implemented by using a calculator having a big data analysis function that is a function of analyzing a large amount of data. In a case where a plurality of the cloud servers 20 is arranged in the cloud system 2, the cloud servers 20 may be arranged to be geographically distributed; however, the field system 1 and the client system 3 execute transmission and reception of data with the cloud servers 20 without being conscious of geographical locations.

The cloud server 20 includes a communication unit 21 that performs transmission and reception of data with the edge device 10, and a communication unit 22 that performs transmission and reception of data with the client 30. In addition, the cloud server 20 includes a data holding unit 23 that holds the extraction field information 71 and the primary analysis information 72 that are data received by the communication unit 21 from the edge device 10, and an analysis unit 24 that performs secondary analysis on the extraction field information 71 and the primary analysis information 72 held by the data holding unit 23. In addition, the cloud server 20 includes a control unit 25 that controls the field system 1, based on the secondary analysis information 74 indicating an analysis result by the analysis unit 24.

The communication unit 21 receives the extraction field information 71 and the primary analysis information 72 from the edge device 10, and sends the information to the data holding unit 23. In addition, the communication unit 21 sends the secondary analysis information 74 generated by the analysis unit 24 to the edge device 10. The secondary analysis information 74 sent by the communication unit 21 to the edge device 10 is information for controlling the field system 1. The data holding unit 23 includes a storage unit such as a memory, and holds the extraction field information 71 and the primary analysis information 72 sent from the communication unit 21.

The analysis unit 24 reads the extraction field information 71 and the primary analysis information 72 from the data holding unit 23, and performs secondary analysis. A processing example of the secondary analysis is processing of analyzing whether ends of lifetimes of the field devices 50A to 50D are close, based on the extraction field information 71 and the primary analysis information 72, by the analysis unit 24. In this case, if it is determined that the ends of the lifetimes of the field devices 50A to 50D are close, the analysis unit 24 generates replacement time information indicating times at which the field devices 50A to 50D should be replaced. The replacement time information generated by the analysis unit 24 is an example of the secondary analysis information 74. Upon generating the secondary analysis information 74, the analysis unit 24 sends the secondary analysis information 74 generated, to the control unit 25 and the communication unit 22.

The analysis unit 24 generates the secondary analysis information 74 to the edge device 10, based on the primary analysis information 72. In a case where the replacement time information is received from the analysis unit 24, the control unit 25 sends the replacement time information to the communication unit 21. As a result, feedback control is executed to the field system 1 by the cloud server 20. That is, the secondary analysis information 74 is feedback data to be used for the feedback control to the field system 1. The communication unit 22 sends the extraction field information 71, the primary analysis information 72, and the secondary analysis information 74 to the client 30.

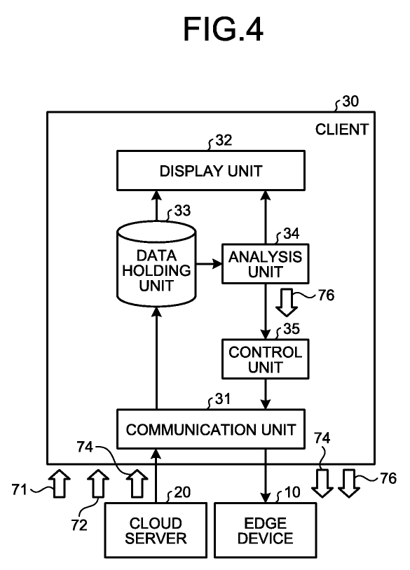

FIG. 4 is a diagram illustrating a configuration of the client according to the first embodiment. The client 30 includes a communication unit 31 that performs transmission and reception of data with the cloud server 20 and the edge device 10. In addition, the client 30 includes a data holding unit 33 that holds the extraction field information 71, the primary analysis information 72, and the secondary analysis information 74 received by the communication unit 31 from the cloud server 20, and an analysis unit 34 that performs tertiary analysis on the extraction field information 71, the primary analysis information 72, and the secondary analysis information 74 held by the data holding unit 33. In addition, the client 30 includes a control unit 35 that controls the field system 1, based on the tertiary analysis information 76 indicating an analysis result by the analysis unit 34. In addition, the client 30 includes a display unit 32 that displays the tertiary analysis information 76 by the analysis unit 34.

The communication unit 31 receives the extraction field information 71, the primary analysis information 72, and the secondary analysis information 74 from the cloud server 20, and sends the information to the data holding unit 33. In addition, the communication unit 31 sends the secondary analysis information 74 and the tertiary analysis information 76 to the edge device 10. The secondary analysis information 74 and the tertiary analysis information 76 are control information for controlling the field system 1. The data holding unit 33 includes a storage unit such as a memory, and holds the extraction field information 71, the primary analysis information 72, and the secondary analysis information 74 sent from the communication unit 31.

The analysis unit 34 reads the secondary analysis information 74 from the data holding unit 33, and determines validity of the secondary analysis information 74. In addition, the analysis unit 34 generates the tertiary analysis information 76 to the edge device 10, by performing tertiary analysis on the secondary analysis information 74. A processing example of the tertiary analysis is processing of changing a parameter to be used for operation of the field system 1 to an appropriate value, by the analysis unit 34, based on a production plan of the field system 1, information on a facility of the field system 1, and inventory information on parts or materials arranged in the field system 1. In this case, the analysis unit 34 calculates the appropriate value of the parameter, and generates parameter information indicating a calculation result.

In addition, another processing example of the tertiary analysis is processing of generating a command for operating the field system 1, by the analysis unit 34, based on the production plan of the field system 1, the information on the facility of the field system 1, and the inventory information on the parts or materials arranged in the field system 1. In this case, the analysis unit 34 generates command information indicating a content of an appropriate command.

The parameter information and the command information generated by the analysis unit 34 are examples of the tertiary analysis information 76. Upon generating the tertiary analysis information 76, the analysis unit 34 sends the tertiary analysis information 76 generated, to the control unit 35 and the display unit 32.

In a case where the parameter information is received, the control unit 35 sends the parameter information to the communication unit 31, and in a case where the command information is received, the control unit 35 sends the command information to the communication unit 31. As a result, feedback control is executed to the field system 1 by the client 30. That is, the tertiary analysis information 76 is feedback data to be used for the feedback control to the field system 1.

The display unit 32 includes a display function such as a liquid crystal monitor, and displays a screen such as a dashboard screen. The display unit 32 displays the extraction field information 71, the primary analysis information 72, the secondary analysis information 74, and the tertiary analysis information 76 on the dashboard screen.

Meanwhile, the edge device 10 is a device for analyzing the field information 70 collected from the field device 50A, and feeding back an analysis result to the field devices 50A to 50D in real time. On the other hand, the cloud server 20 executes, on the field devices 50A to 50D, processing such as preventive maintenance of the field system 1, predictive maintenance of failure of the field system 1, shortening of tact time of processing executed in the field system 1, or quality improvement of a product manufactured in the field system 1. For this reason, the edge device 10 is a device having a property different from that of a device in the higher order side such as the cloud server 20 that performs analysis of big data collected from a plurality of factories without requiring the real-time property.

In the first embodiment, when control is executed in which the real-time property is required, the edge device 10 therefore controls the field devices 50A to 50D by using the primary analysis information 72. In addition, when control is executed in consideration of states of the field devices 50A to 50D, the edge device 10 controls the field devices 50A to 50D by using the tertiary analysis information 76 from the client 30. In addition, when control is executed based on the information collected from the field devices 50A to 50D, the edge device 10 controls the field devices 50A to 50D by using the secondary analysis information 74 from the cloud server 20.

As described above, the information processing system 100 includes the cloud system 2 that performs remote monitoring and analysis using a cloud computing system, and the client system 3 enabled to maintain and operate the field system 1. As a result, the information processing system 100 can control the field system 1 while considering the status of the field system 1 without relying only on a result of the cloud system 2.

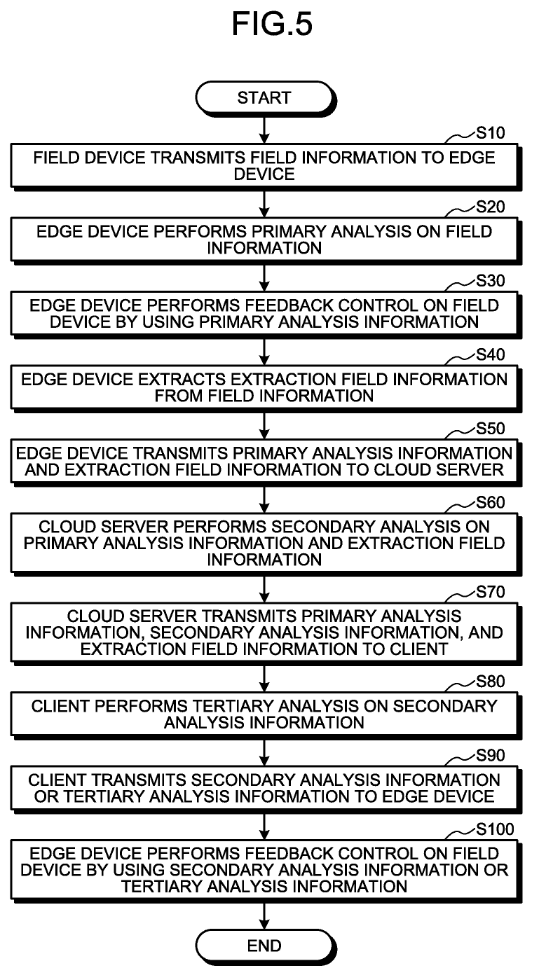

Next, operation processing will be described of the information processing system 100. FIG. 5 is a flowchart illustrating an operation processing procedure of the information processing system according to the first embodiment. The field device 50A collects the field information 70 from the field devices 50B to 50D. Then, in step S10, the field device 50A transmits the field information 70 to the edge device 10.

As a result, the edge device 10 receives the field information 70 with the communication unit 11, and the data holding unit 13 temporarily holds the field information 70 received. Then, in step S20, the edge device 10 performs primary analysis on the field information 70. Specifically, the analysis unit 14 reads the field information 70 from the data holding unit 13, and performs primary analysis on the field information 70. Then, the analysis unit 14 generates the primary analysis information 72 that is a result of the primary analysis. An example of the primary analysis information 72 is the stop instruction information or the skip instruction information described above.

Further, in step S30, the edge device 10 performs feedback control on the field devices 50A to 50D by using the primary analysis information 72. Specifically, the control unit 15 sends the primary analysis information 72 to the communication unit 11, and the communication unit 11 sends the primary analysis information 72 to the field device 50A. Then, the field device 50A executes processing, based on the primary analysis information 72. As a result, the field device 50A controls the field devices 50B to 50D. As described above, the edge device 10 controls the field devices 50A to 50D in real time by transmitting the primary analysis information 72 to the field device 50A.

In addition, in step S40, the edge device 10 extracts the extraction field information 71 from the field information 70. Specifically, the data sorting unit 16 of the edge device 10 sets, as the extraction field information 71, data that may be transmitted to the cloud server 20 in the field information 70. An example of the extraction field information 71 is data not necessary for real-time control, or enormous data collected by a plurality of the field systems 1 and to be used for the predictive maintenance of failure and the like. The data sorting unit 16 sends the extraction field information 71 determined as the data that may be transmitted to the cloud server 20, to the communication unit 12. In addition, the analysis unit 14 sends the primary analysis information 72 to the communication unit 12.

Then, in step S50, the edge device 10 transmits the primary analysis information 72 and the extraction field information 71 to the cloud server 20. Specifically, the communication unit 12 of the edge device 10 transmits the primary analysis information 72 and the extraction field information 71 to the communication unit 21 of the cloud server 20.

As a result, the communication unit 21 of the cloud server 20 receives the primary analysis information 72 and the extraction field information 71 from the edge device 10. In addition, the data holding unit 23 of the cloud server 20 temporarily holds the primary analysis information 72 and the extraction field information 71.

Then, in step S60, the cloud server 20 performs secondary analysis on the primary analysis information 72 and the extraction field information 71. Specifically, the analysis unit 24 reads the primary analysis information 72 and the extraction field information 71 from the data holding unit 23, and performs secondary analysis. The primary analysis information 72 is data to be used for the real-time control to the field devices 50A to 50D, and the extraction field information 71 is data to be used for the predictive maintenance of failure of the field devices 50A to 50D. Since the cloud server 20 executes the secondary analysis using various data relating to the field devices 50A to 50D, it is possible to execute detailed secondary analysis on the field devices 50A to 50D. As described above, the big data such as the primary analysis information 72 and the extraction field information 71 are useful for detailed secondary analysis by the cloud server 20. An example of the secondary analysis information 74 that is a result of the secondary analysis is the replacement time information described above.

In addition, in step S70, the cloud server 20 transmits the primary analysis information 72, the secondary analysis information 74, and the extraction field information 71 to the client 30. Specifically, the communication unit 22 of the cloud server 20 transmits the primary analysis information 72, the secondary analysis information 74, and the extraction field information 71 to the communication unit 31 of the client 30.

The cloud server 20 has the big data analysis function and can perform automatic control on the field device 50A. However, the cloud server 20 merely receives and manages the primary analysis information 72 and the extraction field information 71, and does not store the production plan of the field system 1, the information on the facility of the field system 1, and the inventory information on the parts and materials arranged in the field system 1. On the other hand, since the client 30 is a device that operates and maintains the field system 1, the client 30 stores the production plan of the field system 1, the information on the facility of the field system 1, and the inventory information on the parts and materials arranged in the field system 1.

Thus, in the first embodiment, the cloud server 20 does not directly control the field device 50A, but the client 30 controls the field system 1. In this case, the communication unit 31 of the client 30 receives the secondary analysis information 74, the primary analysis information 72, and the extraction field information 71 from the cloud server 20. Then, the data holding unit 33 of the client 30 temporarily holds the secondary analysis information 74, the primary analysis information 72, and the extraction field information 71.

Then, the display unit 32 displays the secondary analysis information 74 on the dashboard screen. As a result, it becomes possible to allow the user of the client 30 to confirm the content of the secondary analysis information 74. In addition, the display unit 32 may display, on the dashboard screen, the primary analysis information 72 and the extraction field information 71 held in the data holding unit 33. As a result, it becomes possible to allow the user to confirm validity of the primary analysis information 72 and the extraction field information 71. In addition, it becomes possible to allow the user to confirm the validity of the secondary analysis information 74 in a case where the secondary analysis information 74 and the primary analysis information 72 are compared with each other, and the validity of the secondary analysis information 74 in a case where the secondary analysis information 74 and the extraction field information 71 are compared with each other. At this time, the client 30 may accept information from the user based on user's rule of thumb. As a result, the client 30 is enabled to execute processing corresponding to the information from the user.

In a case where the information from the user is a determination result indicating whether the secondary analysis information 74 is valid, the client 30 accepts the determination result input by the user. In a case where the client 30 includes an input device such as a mouse or a keyboard, the input device accepts the determination result from the user. In addition, in a case where the display unit 32 includes a touch panel, the touch panel accepts the determination result from the user. In this case, the analysis unit 34 determines whether there is a problem when the secondary analysis information 74 is fed back to the field system 1, based on the determination result from the user.

In addition, the analysis unit 34 may automatically determine whether there is a problem when the secondary analysis information 74 is fed back to the field system 1. Here, automatic analysis processing will be described of the secondary analysis information 74 by the analysis unit 34. The secondary analysis information 74 may be information indicating change to a parameter that can shorten a production time to the shortest in a plurality of processing lines. In this case, since the client 30 grasps a production status of the field system 1, it is possible to grasp that there is another processing line to be a bottleneck on the production line. The analysis unit 34 therefore analyzes the processing lines, based on the production status of the field system 1, and calculates a parameter of a processing line that can shorten a production time of the entire processing lines. As a result, the analysis unit 34 can automatically analyze the secondary analysis information 74 without leaving the determination to the user.

When it is determined that there is no problem even when the secondary analysis information 74 is fed back to the field system 1, the analysis unit 34 sets the secondary analysis information 74 as feedback data, and sends the feedback data to the control unit 35. Then, the control unit 35 sends the secondary analysis information 74 from the communication unit 31 to the edge device 10. As a result, the edge device 10 sends the secondary analysis information 74 to the field device 50A, and the field device 50A controls the field devices 50B to 50D by using the secondary analysis information 74.

In addition, in a case where the secondary analysis information 74 is invalid, or based on the production plan of the field system 1, the information on the facility of the field system 1, and the inventory information on the parts or materials arranged in the field system 1, the analysis unit 34 may determine that further analysis is necessary. In this case, in step S80, the client 30 performs tertiary analysis on the secondary analysis information 74. At this time, the analysis unit 34 generates the tertiary analysis information 76 by performing analysis that changes the parameter not to affect quality management of the field system 1.

Specifically, the analysis unit 34 reads the secondary analysis information 74 from the data holding unit 33, and performs tertiary analysis. The tertiary analysis information 76 corresponds to an examination result of the secondary analysis information 74 examined by the client 30. An example of the tertiary analysis information 76 is information generated in consideration of the status of the field system 1 such as the production plan of the field system 1. As described above, the secondary analysis information 74 is information to be automatically generated by the computer, and the tertiary analysis information 76 is information to be generated by the human with flexible determination for various events. The tertiary analysis information 76 is organized and displayed on the display unit 32 to be easily determined by the human, and is reflected in the field devices 50A to 50D only after the determination by the human.

Then, in step S90, the client 30 transmits the secondary analysis information 74 or the tertiary analysis information 76 to the edge device 10. Specifically, the analysis unit 34 of the client 30 sets the secondary analysis information 74 or the tertiary analysis information 76 as feedback data, and sends the feedback data to the control unit 35. In a case where the secondary analysis information 74 is valid, the analysis unit 34 sends the secondary analysis information 74 to the control unit 35, and in a case where the secondary analysis information 74 is invalid, the analysis unit 34 sends the tertiary analysis information 76 to the control unit 35. Further, the control unit 35 sends the secondary analysis information 74 or the tertiary analysis information 76 from the communication unit 31 to the edge device 10. As a result, the communication unit 12 of the edge device 10 receives the secondary analysis information 74 or the tertiary analysis information 76, and sends the received information to the control unit 15. Then, the control unit 15 converts the secondary analysis information 74 or the tertiary analysis information 76 into the format interpretable by the field device 50A, and sends the converted information to the field device 50A.

As a result, in step S100, the edge device 10 performs feedback control on the field device 50A by using the secondary analysis information 74 or the tertiary analysis information 76. As a result, the field device 50A controls the field devices 50B to 50D by using the secondary analysis information 74 or the tertiary analysis information 76.

As described above, in the first embodiment, the client 30 transmits the secondary analysis information 74 or the tertiary analysis information 76 to the edge device 10, whereby the field devices 50A to 50D are controlled by the client 30.

In the information processing system 100, when the cloud server 20 controls the field system 1, control may be performed at a timing unintended by the field system 1. For example, in the production plan of the field system 1, there is an operation plan in a busy season in which it is not desired to stop the operation of the field system 1. When the cloud server 20 stops the field system 1 at such timing and causes the field system 1 to execute the maintenance work, operation efficiency of the field system 1 decreases, and the production plan is greatly affected. In addition, when the cloud server 20 controls the field system 1, the cloud server 20 cannot flexibly respond to an unplanned event, such as a case where an artificial mistake occurs, a case where a defective item due to a device failure occurs, a case where there is a sudden change in the production plan, or a case where business is continued at the time of sudden disaster. In addition, in a case where the cloud server 20 controls the field system 1, the cloud server 20 has not been able to give the field devices 50A to 50D in the factory know-how generated from experiences of users so far. For example, although the cloud server 20 can execute specific processing, since the specific processing does not involve a user, control depending on the know-how of the user cannot be executed to the field system 1.

In the first embodiment, the control using the secondary analysis information 74 and the control using the tertiary analysis information 76 are executed by the client 30 that allows involvement of the user. For this reason, it is possible to construct a distributed system in which the user and the computer cooperate with each other. As a result, in the first embodiment, it is possible for the client 30 to reduce a risk on system management in the field system 1.

As described above, in the first embodiment, the edge device 10 generates the primary analysis information 72 by performing primary analysis on the field information 70 from the field devices 50A to 50D, and extracts the extraction field information 71 from the field information 70. In addition, the cloud server 20 generates the secondary analysis information 74 by performing secondary analysis on the primary analysis information 72 and the extraction field information 71. Further, the client 30 transmits the secondary analysis information 74 or the tertiary analysis information 76 generated based on the secondary analysis information 74, to the edge device 10. Then, the edge device 10 controls the field devices 50A to 50D by using the secondary analysis information 74 or the tertiary analysis information 76.

With this configuration, the edge device 10 can control the field devices 50A to 50D by using the primary analysis information 72 in a case where the real-time property is required. In addition, in a case where control based on statuses of the field devices 50A to 50D is required, the edge device 10 can control the field devices 50A to 50D by using the secondary analysis information 74 or the tertiary analysis information 76. The edge device 10 can therefore execute the control in which the real-time property is required and the control based on the statuses of the field devices 50A to 50D while reducing the risk on the system management in the field system 1.

### Second Embodiment

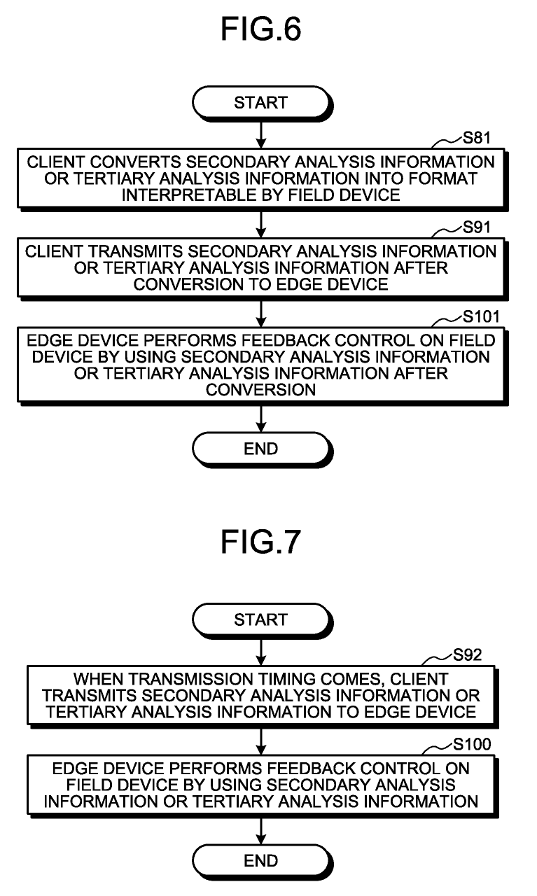

Next, a second embodiment of the present invention will be described with reference to FIG. 6. In the second embodiment, the client 30 converts the primary analysis information 72, the secondary analysis information 74, or the tertiary analysis information 76 into the format interpretable by the field device 50A, and transmits the converted information to the edge device 10.

FIG. 6 is a flowchart illustrating an operation processing procedure of the information processing system according to the second embodiment. Note that, the information processing system 100 according to the second embodiment has the same configuration as the information processing system 100 according to the first embodiment. In addition, since the processing of steps S10 to S80 executed by the information processing system 100 according to the second embodiment is the same as the processing of steps S10 to S80 executed by the information processing system 100 of the first embodiment, description thereof will be omitted.

The client 30 receives the extraction field information 71, the primary analysis information 72, and the secondary analysis information 74 from the cloud server 20. In addition, in a case where the secondary analysis information 74 is invalid, or in a case where further analysis is necessary in consideration of a status of the field system 1, the client 30 performs tertiary analysis on the secondary analysis information 74.

Then, in step S81, the client 30 converts the secondary analysis information 74 or the tertiary analysis information 76 into the format interpretable by the field device 50A. In this case, when determining that there is no problem even when the secondary analysis information 74 is fed back to the field system 1, the control unit 35 converts the secondary analysis information 74 into first information in the format interpretable by the field device 50A. In addition, in a case where the tertiary analysis information 76 is generated, the control unit 35 converts the tertiary analysis information 76 into second information of the format interpretable by the field device 50A. Note that, the control unit 35 may convert the primary analysis information 72 into the format interpretable by the field device 50A in a case where it is determined that there is no problem even when the primary analysis information 72 is fed back to the field system 1.

After the client 30 converts the secondary analysis information 74 or the tertiary analysis information 76, the client 30 transmits the secondary analysis information 74 or the tertiary analysis information 76 after the conversion, to the edge device 10 in step S91. Specifically, in a case where the secondary analysis information 74 is subjected to the format conversion by the control unit 35, the communication unit 31 sends the secondary analysis information 74 after the conversion, to the communication unit 12 of the edge device 10. In addition, in a case where the tertiary analysis information 76 is subjected to the format conversion by the control unit 35, the communication unit 31 sends the tertiary analysis information 76 after the conversion, to the communication unit 12 of the edge device 10.

Thereafter, in step S101, the edge device 10 performs feedback control on the field devices 50A to 50D by using the secondary analysis information 74 or the tertiary analysis information 76 after the conversion. Specifically, in a case where the secondary analysis information 74 after the conversion is received from the client 30, the control unit 15 controls the field devices 50A to 50D by using the secondary analysis information 74 after the conversion. In addition, in a case where the tertiary analysis information 76 after the conversion is received from the client 30, the control unit 15 controls the field devices 50A to 50D by using the tertiary analysis information 76 after the conversion. Note that, in a case where the primary analysis information 72 after the conversion is received from the client 30, the control unit 15 may control the field devices 50A to 50D by using the primary analysis information 72 after the conversion.

In the information processing system 100, there is a case where the field device 50A cannot interpret the primary analysis information 72, the secondary analysis information 74, or the tertiary analysis information 76. Thus, in the second embodiment, the control unit 35 of the client 30 converts the primary analysis information 72, the secondary analysis information 74, and the tertiary analysis information 76 into the formats interpretable by the field device 50A, and transmits the converted information to the edge device 10. Then, the edge device 10 controls the field devices 50A to 50D by using the analysis information after the conversion. As a result, the field device 50A can interpret the analysis information and control the field devices 50B to 50D. Note that, in the second embodiment, the control unit 15 does not have to have a function of converting the secondary analysis information 74 and the tertiary analysis information 76 into the formats interpretable by the field device 50A.

As described above, according to the second embodiment, since the format conversion that is one of the control functions of the field system 1 is executed by the client system 3, the client system 3 can directly controls the field system 1.

### Third Embodiment

Next, a third embodiment of the present invention will be described with reference to FIG. 7. In the third embodiment, the client 30 sends the secondary analysis information 74 and the tertiary analysis information 76 to the field system 1 at an arbitrary timing in consideration of a status of the field system 1.

FIG. 7 is a flowchart illustrating an operation processing procedure of the information processing system according to the third embodiment. Note that, the information processing system 100 of the third embodiment has the same configuration as the information processing system 100 of the first embodiment. In addition, the processing of steps S10 to S80, and S100 executed by the information processing system 100 of the third embodiment is the same as the processing of steps S10 to S80, and S100 executed by the information processing system 100 of the first embodiment, description thereof will be omitted.

The client 30 receives the primary analysis information 72, the secondary analysis information 74, and the extraction field information 71 from the cloud server 20. In addition, in a case where the secondary analysis information 74 is invalid, or in a case where further analysis is necessary in consideration of the status of the field system 1, the client 30 performs tertiary analysis on the secondary analysis information 74.

Then, in step S92, when a preset transmission timing comes, the client 30 transmits the secondary analysis information 74 or the tertiary analysis information 76 to the edge device 10. Specifically, when the transmission timing comes, the analysis unit 34 of the client 30 sets the secondary analysis information 74 or the tertiary analysis information 76 as feedback data, and sends the feedback data to the control unit 35.

Note that, the timing at which the client 30 transmits the secondary analysis information 74 or the tertiary analysis information 76 to the edge device 10 may be set by the user, or may be set by the analysis unit 34, based on the production plan of the field system 1, the information on the facility of the field system 1, and the inventory information on the parts or materials arranged in the field system 1.

As described above, in a case where the client 30 controls the field system 1, the client 30 can feed back the secondary analysis information 74 and the tertiary analysis information 76 to the field system 1 at the arbitrary timing. For example, there is a case where the primary analysis information 72 is real-time control to an expendable item arranged in the field system 1, and the secondary analysis information 74 is a replacement time of the expendable item arranged in the field system 1. In this case, in a case where the replacement time of the expendable item arranged in the field system 1 is close, the client 30 sends a replacement instruction of the expendable item to the field system 1 at a timing based on an operating status of the field system 1, not a timing at which the validity of the secondary analysis information 74 is determined, or a timing at which the tertiary analysis is performed. In a case where the field system 1 stops operation during the night and operates in the morning of the next day, the client 30 sends the replacement time of the expendable item that is an example of the secondary analysis information 74 or the replacement instruction of the expendable that is an example of the tertiary analysis information 76, to the field system 1 before the field system 1 operates. As a result, the client 30 can control the field system 1 at a timing based on the production plan of the field system 1, the information on the facility of the field system 1, and the inventory information on the parts or materials arranged in the field system 1.

As described above, according to the third embodiment, the client system 3 sends the secondary analysis information 74 and the tertiary analysis information 76 to the field system 1 when the transmission timing comes, so that the client system 3 can control the field system 1 at the timing in consideration of the status of the field system 1.

### Fourth Embodiment

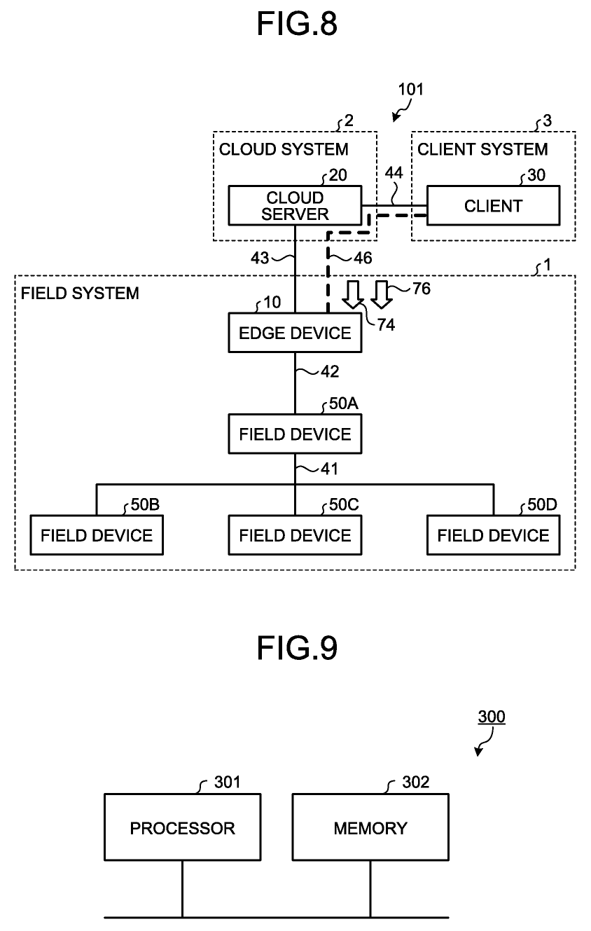

Next, a fourth embodiment of the present invention will be described with reference to FIGS. 8 and 9. In the fourth embodiment, the client 30 is not directly connected to the edge device 10 but is connected via the cloud server 20.

FIG. 8 is a diagram illustrating a configuration of an information processing system according to the fourth embodiment. An information processing system 101 includes the field system 1, the cloud system 2, and the client system 3. Then, the field system 1 is connected to the cloud system 2 via the access network 43, and the cloud system 2 is connected to the client system 3 via the communication line 44. Then, the client system 3 is not connected to the field system 1 via the communication line 45. Note that, in FIG. 8, among the field information 70, the extraction field information 71, the primary analysis information 72, the secondary analysis information 74, and the tertiary analysis information 76, illustration is omitted of other than the secondary analysis information 74 and the tertiary analysis information 76 sent by the client 30 to the edge device 10.

The client 30 of the fourth embodiment sends the secondary analysis information 74 and the tertiary analysis information 76 to the edge device 10 via the cloud server 20. In other words, the client 30 sends the secondary analysis information 74 and the tertiary analysis information 76 to the edge device 10 via a communication path 46 passing through the communication line 44, the cloud server 20, and the access network 43.

As described above, the client 30 is connected to the edge device 10 via the cloud system 2 logically separated. In a case where the information processing system 101 uses Security architecture for Internet Protocol (IPsec), information is encrypted in the cloud system 2, and the client 30 and the edge device 10 are connected together via the communication path 46. For this reason, the client 30 can execute communication with the edge device 10 without execution of data processing by the cloud server 20.

As described above, according to the fourth embodiment, the information processing system 101 includes the communication path 46 logically between the client 30 and the edge device 10. As a result, in a case where the client 30 is arranged in the information processing system 101, there is no need to arrange the communication line 45 that is a physical connection line for the client 30 and the edge device 10.

Next, hardware configurations will be described of the edge device 10, the cloud server 20, and the client 30. Note that, since the edge device 10, the cloud server 20, and the client 30 have similar hardware configurations, here, the configuration will be described of the client 30.

FIG. 9 is a diagram illustrating a hardware configuration example of the client according to the first to fourth embodiments. The client 30 can be implemented by a control circuit 300 illustrated in FIG. 9, that is, a processor 301 and a memory 302. An example of the processor 301 is a CPU (also referred to as a central processing device, a processing device, an arithmetic device, a microprocessor, a microcomputer, a processor, or a DSP), or a system large scale integration (LSI). An example of the memory 302 is a random access memory (RAM), a read only memory (ROM), or a flash memory.

The client 30 is implemented by the processor 301 reading and executing a program stored in the memory 302 for executing operation of the client 30. In addition, it can also be said that the program causes a computer to execute a procedure or a method of the client 30. The memory 302 is also used as a temporary memory when the processor 301 executes various types of processing.

As described above, the program executed by the processor 301 is a computer program product including a computer readable and non-transitory recording medium including a plurality of instructions for executing data processing that can be executed by the computer. The program executed by the processor 301 causes the computer to execute data processing by the plurality of instructions.

Note that, in the client 30, one of the analysis unit 34 or the control unit 35 may be implemented by the control circuit 300. In addition, in the edge device 10, any one of the analysis unit 14, the control unit 15, or the data sorting unit 16 may be implemented by the control circuit 300. In addition, in the cloud server 20, one of the analysis unit 24 or the control unit 25 may be implemented by the control circuit 300. In addition, a function of the edge device 10, the cloud server 20, or the client 30 may be partially implemented by dedicated hardware, and partially implemented by software or firmware.

The configurations described in the above embodiments describe examples of contents of the present invention, and can be combined with other known techniques, and also a part of the configuration can be omitted or modified without departing from the gist of the present invention.

### REFERENCE SIGNS LIST

1 field system; 2 cloud system; 3 client system; 10 edge device; 11, 12, 21, 22, 31 communication unit; 13, 23, 33 data holding unit; 14, 24, 34 analysis unit; 15, 25, 35 control unit; 16 data sorting unit; 20 cloud server; 30 client; 32 display unit; 41, 42 field network; 43 access network; 44, 45 communication line; 46 communication path; 50A to 50D field device; 70 field information; 71 extraction field information; 72 primary analysis information; 74 secondary analysis information; 76 tertiary analysis information; 100, 101 information processing system.

1. An information processing system comprising:
a field device to output first information to be subjected to information processing;
primary analysis circuitry configured to execute generating primary analysis information that is a result of primary analysis by executing the primary analysis that is processing of analyzing a state of the field device by using the first information, and to execute extracting second information from the first information;
secondary analysis circuitry configured to generate secondary analysis information by performing secondary analysis on the primary analysis information and the second information; and
client circuitry configured to generate control information for controlling the field device or for the field device to operate, based on the secondary analysis information,
wherein the primary analysis circuitry controls the field device or causes the field device to operate, by using the control information based on a status of the field device.

2. The information processing system according to claim 1, wherein:
the secondary analysis circuitry is connected to the field device via the primary analysis circuitry.

3. The information processing system according to claim 1, wherein:
the client circuitry determines whether to reflect the secondary analysis information in the field device, and in a case where it is determined that the secondary analysis information is to be reflected, the client circuitry sets the secondary analysis information as the control information, and transmits the control information to the primary analysis circuitry.

4. The information processing system according to claim 1, wherein:
the client circuitry converts the secondary analysis information into first information interpretable by the field device, and controls the field device by using the first information.

5. The information processing system according to claim 1, wherein:
the client circuitry generates tertiary analysis information by performing tertiary analysis on the secondary analysis information, sets the tertiary analysis information as the control information, and transmits the control information to the primary analysis circuitry.

6. The information processing system according to claim 5, wherein:
the client circuitry generates the tertiary analysis information in accordance with an instruction input by a user.

7. The information processing system according to claim 5, wherein:
the client circuitry converts the tertiary analysis information into second information interpretable by the field device, sets the second information as the control information, and transmits the control information to the primary analysis circuitry.

8. The information processing system according to claim 1, wherein:
the client circuitry transmits the control information to the primary analysis circuitry at a preset specific timing.

9. The information processing system according to claim 1, wherein:
the client circuitry controls the field device via the primary analysis circuitry.

10. The information processing system according to claim 1, wherein:
the client circuitry transmits the control information to the field device via the secondary analysis circuitry and the primary analysis circuitry.

11. An information processing method comprising:
outputting, by a field device, first information to be subjected to information processing;
generating, by primary analysis circuitry, primary analysis information that is a result of primary analysis by executing primary analysis that is processing of analyzing a state of the field device by using the first information;
extracting, by the primary analysis circuitry, second information from the first information;
generating, by secondary analysis circuitry, secondary analysis information by performing secondary analysis on the primary analysis information and the second information;
generating, by client circuitry, control information for controlling the field device or for the field device to operate, based on the secondary analysis information; and
controlling, by the primary analysis circuitry, the field device or causing the field device to operate, by using the control information based on a status of the field device.
